(19) United States
(12) Patent Application Publication
(10) Pub. No.: US 2003/0194684 A1
(43) Pub. Date: Oct. 16, 2003

(54) Accelerated exam preparation system and method

(76) Inventor: Michelle LaBrosse, East Hartford, CT (US)

Correspondence Address: HOFFMAN WARNICK & D'ALESSANDRO, LLC, 3 E-COMM SQUARE, ALBANY, NY, 12207

(21) Appl. No.: 10/411,443

(22) Filed: Apr. 10, 2003

Related U.S. Application Data
(60) Provisional application No. 60/371,822, filed on Apr. 11, 2002.

(51) Int. Cl. G09B 19/00

(52) U.S. Cl. 434/236

(57) ABSTRACT

An accelerated exam preparation system and method that plans a preparation schedule for the student, relaxes the mind of a student, and presents content to the student in a graphical manner. The system and method reduce the amount of study time required by the student in preparing for an exam by incorporating environmental, lifestyle and/or sensory aspects designed to assist the student in quickly learning and recalling the content.

### REFERENCE TO PRIOR APPLICATION

The current application claims priority to co-pending provisional application serial No. 60/371,822, filed on Apr. 11, 2002 and incorporated herein by reference.

### BACKGROUND OF THE INVENTION

1. Technical Field

The invention relates generally to exam preparation, and more specifically to a system and method for accelerating exam preparation

2. Related Art

Certification testing is becoming increasingly popular in the business environment. For example, project managers can seek certification from the Project Management Institute (PMI®) by taking and passing a Project Management Professional (PMP®) Exam. Obtaining a certification such as this is intended to assure an employer/prospective employer that the certified individual knows and understands the standards that these groups set. As a result, it is hoped that the individual follows the standards in practice, resulting in an elevated quality of work. Other traditional tests also remain highly important. For example, high scores on tests such as the Scholastic Aptitude Test (SAT), the Law School Admission Test (LSAT), and the Medical College Admission Test (MCAT) can be the difference in getting accepted at a desired college/university in a highly competitive admissions environment. Further, a low score on a state's Bar Exam or medical Board Exam may prevent an individual from obtaining a license to provide services in a professional field after years of specialized, expensive training.

In light of the importance of these exams, there exists a high demand for exam preparation products. Numerous products exist on the market that seek to fulfill the demand for exam preparation for these and many other exams. However, most of these products are tailored specifically to a particular exam or content area. Further, most of the existing products are content driven, and merely attempt to summarize the content area or provide strategies for time management and/or answering multiple choice questions. As a result, existing exam preparation products fail to provide any benefit beyond the short term goal of passing an exam. Further, existing exam preparation products only provide mixed results since they fail to address the numerous life style factors that impact memory and recall.

As exams for professionals become increasingly popular, the desire to reduce the amount of time traditionally taken for exam preparation has increased. For example, a company may desire that its project managers be certified by the PMI®. However, each day of work that an employee uses to prepare for the PMP® Exam costs the employer a day of productivity. Further, an individual may desire certification quickly when seeking new employment, a new and/or a higher salary.

As a result, a need exists for an accelerated exam preparation product that provides a comprehensive approach to assisting individuals in the accelerated preparation of exams.

### SUMMARY OF THE INVENTION

The invention provides a system and method for accelerating the preparation of a student for an exam. The invention combines mind relaxation with rapid synthesis to reduce the amount of preparation time for the student. The unique combination ensures that the mind is in a state of relaxed concentration while a large amount of content is presented in a way that speeds instant recall. A planning component is further used to maintain the focus of the student. Other optional components include adjusting the student's diet and/or exercise, as well as further using recordings designed to improve the test taking confidence of the student.

A first aspect of the invention provides an accelerated exam preparation system, comprising: a planning component for planning a preparation schedule for a student; a mind relaxation component for relaxing the mind of the student; and a rapid synthesis component for presenting content to the student in a graphical manner.

A second aspect of the invention provides a method for preparing a student for an exam, comprising: advising the student on improving at least one of: a physical state and a mental state of the student; and providing a course to the student, the course comprising: planning a preparation schedule for the student; relaxing the mind of the student during the course; and presenting content to the student in a graphical manner.

A third aspect of the invention provides an accelerated exam preparation system, the system comprising: a lifestyle management component for advising a student on improving at least one of: a physical state and a mental state; a planning component for planning a preparation schedule for the student; a mind relaxation component that includes a musical recording having a range of about sixteen Hertz; and a rapid synthesis component for presenting content to the student in a graphical manner.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system according to one embodiment of the invention;

FIG. 2 depicts a method according to another embodiment of the invention;

FIG. 3 depicts an illustrative planning poster; and

FIG. 4 depicts an illustrative mind map.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The invention provides a system and method for accelerating the preparation of a student for an exam. The invention combines mind relaxation with rapid synthesis to reduce the amount of preparation time for the student. The unique combination ensures that the mind is in a state of relaxed concentration while a large amount of content is presented in a way that speeds instant recall. A planning component is further used to maintain the focus of the student. Other optional components include adjusting the student's diet and/or exercise, as well as further using recordings designed to improve the test taking confidence of the student.

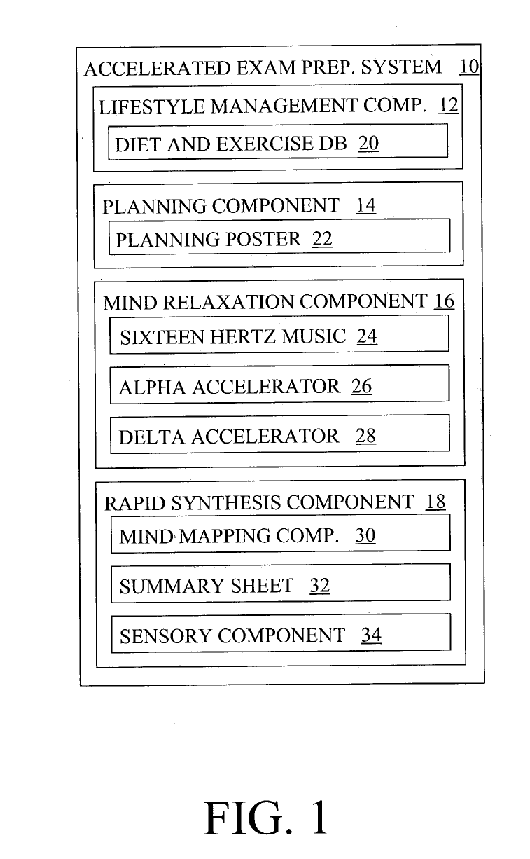

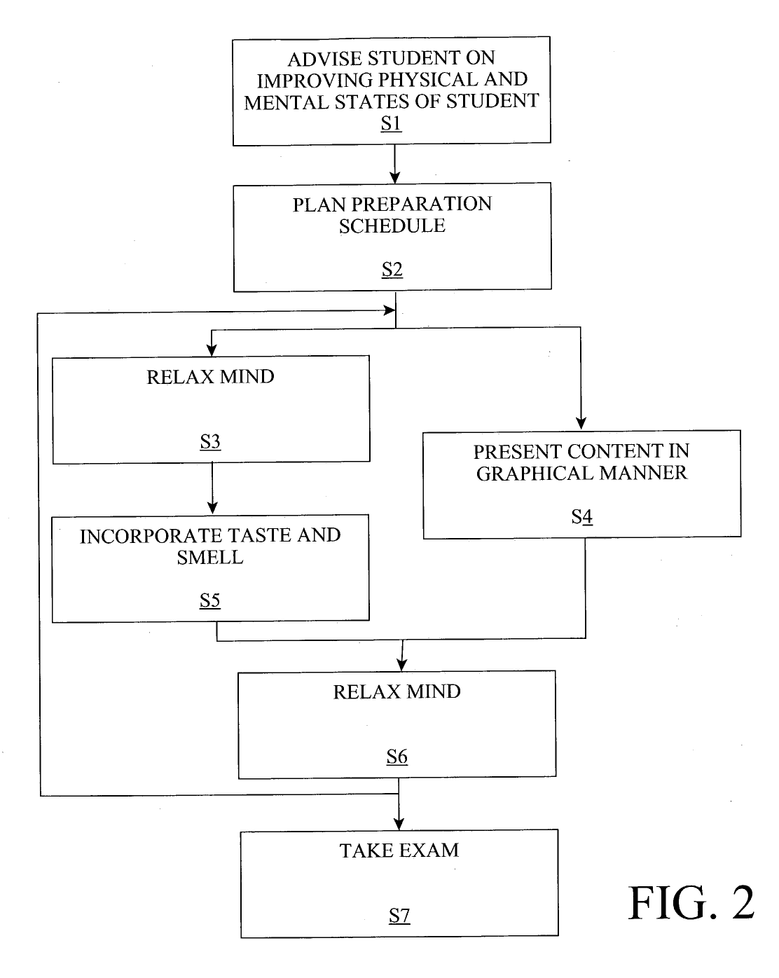

Turning to the Figures, FIG. 1 depicts an illustrative accelerated exam preparation system 10. Accelerated exam preparation system 10 includes a lifestyle management component 12, a planning component 14, a mind relaxation component 16, and a rapid synthesis component 18. Each component is integrated with the various other components during the exam preparation of a student to ensure that the student's mind is in an improved state for assimilating information, recalling information, and that the user has an elevated degree of confidence to take the exam. The functions performed by each component are further discussed with reference to FIG. 2 which depicts an illustrative method according to one embodiment of the invention.

In step S1 of FIG. 2, the student is advised on improving physical and mental states of the student by lifestyle management component 12 (FIG. 1). Lifestyle management component 12 includes information for improving the physical state and/or mental state of the student. The information address issues regarding diet, exercise, and/or lifestyle adjustments that improve the mental performance of the student. These adjustments may or may not be required or implemented by the student with or without the assistance of a doctor. The information can be contained in a diet and exercise database 20 that the student accesses using specialized computer software, presented in a writing such as a book or pamphlet, presented on an Internet web site, etc.

The adjustments can include, for example, a regimen of supplements, in particular the B-Complex, C, and E vitamins. In one embodiment, lifestyle management component 12 advises the student to take 500 milligrams of vitamin C, 400 milligrams of vitamin E, and a general B-Complex vitamin daily. Lifestyle management component 12 can also include additional literature or references to literature that detail the importance of vitamins with regard to mental performance. Lifestyle management component 12 can also recommend that the student research and/or take other memory supplements, such as ginko biloba. While memory supplements may not be proven to positively impact mental performance, a placebo effect for the student may provide more confidence in his/her memory resulting in better exam performance.

Lifestyle management component 12 can further suggest an adjustment to the intake of at least one drug by the student. In particular, lifestyle management component 12 can suggest that the student eliminate caffeine, nicotine, alcohol and/or “illegal” drugs from the student's diet, and/or suggest that the student evaluate the effect of other prescription/non-prescription drugs on mental performance and consult with a doctor about options for eliminating or reducing those drugs that adversely impact mental performance. Because of the time that may be required to reduce or eliminate one or more drugs from the student's life, lifestyle management component 12 can be introduced to the student one or more months prior to the student taking the exam. This provides the student with ample time to slowly reduce drug intake, consult with a doctor, etc. Alternatively, the student can be advised to refrain from alcohol and caffeine at least the night before and day of the exam.

Lifestyle management component 12 can further advise the student on diet. For example, the student can be advised to consume protein rather than carbohydrates, especially in the morning, to stimulate the student's production of an amino acid called Tyrosine that has been shown to boost mental performance. Alternatively, the student can shift the intake of carbohydrates to be roughly ten minutes after eating protein, or later in the day to help promote a restful sleep. For the test morning, the student is advised to eat a high protein breakfast, and bring protein snacks for the exam.

Lifestyle management component 12 can also advise the student on exercise. For example, the student can be advised to exercise at least three times a week. Further, lifestyle management component 12 can further advise the student that the exercise preferably comprises walking, jogging, and/or swimming sufficiently to sweat for about twenty minutes. With an exercise program, lifestyle management component 12 can suggest that the program be implemented at least one month prior to the exam, and be supplemented with a daily relaxing walk during the week leading up to the exam.

Lifestyle management component 12 can also advise the student on sleep. For example, the student can be advised to ensure that the student gets adequate and restful sleep every night for at least the week prior to the exam. The student can be advised that he/she may desire to seek a quiet location (e.g., hotel) leading up to the exam if, for example, infants or young children prevent restful sleep at home. Further, the student can be advised to stay close to the location of the exam the night before so that a long drive is not required in the morning.

Since the accelerated exam preparation of the invention uses rapid synthesis techniques, it is important that the student maintain focus and motivation during the exam preparation. In step S2, a preparation schedule for the student is prepared using planning component 14 (FIG. 1). The preparation schedule assists the student in staying focused and motivated during exam preparation. The preparation schedule can comprise, for example, a poster 22 provided to the student as part of a kit or an electronic schedule of activities accessed over, for example, the Internet. The preparation schedule can be complete when provided or each student can use a partially completed preparation schedule to create a custom accelerated exam preparation schedule. In the case of the latter, techniques outlined in the book Accelerated Project Management by Michelle LaBrosse and hereby incorporated by reference, can be used to enable the student to develop the preparation schedule.

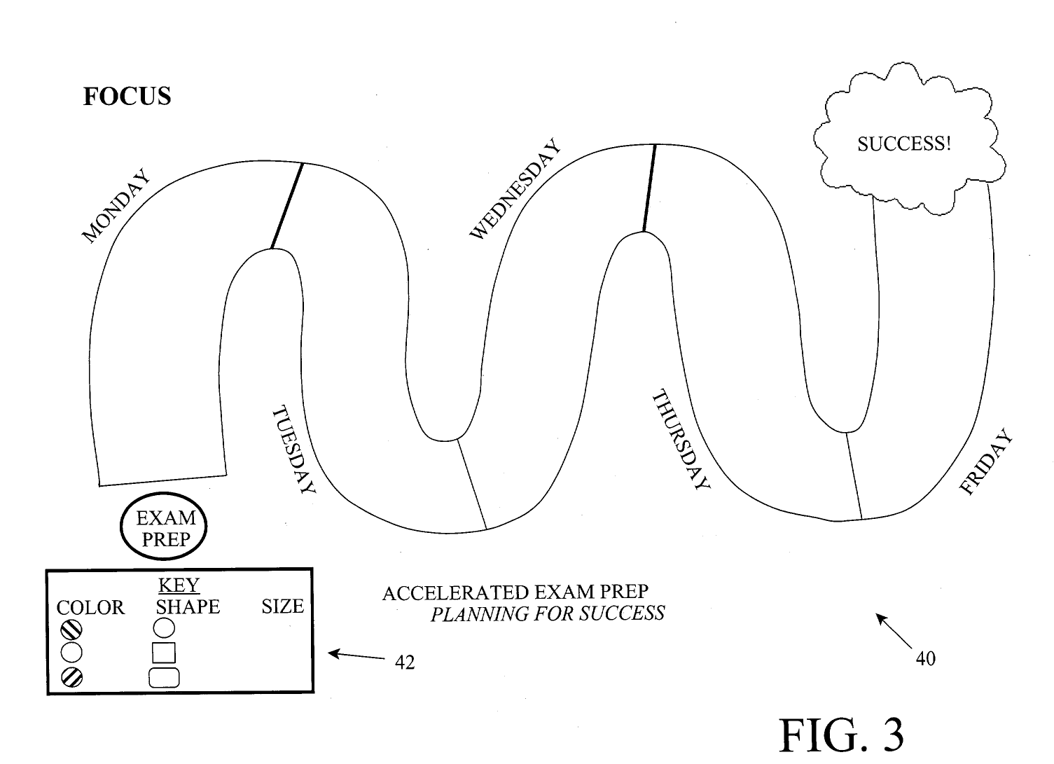

In one embodiment, the student plans the preparation schedule on a wall poster for quick reference. FIG. 3 depicts an illustrative wall poster 40 for an accelerated exam preparation program that lasts five days. Poster 40 includes a key 42 that specifies meanings assigned to various shapes, colors and/or sizes used in generating the preparation schedule. Key 42 can be complete when included with a blank poster 40, or each student can be allowed to assign colors, shapes, and/or sizes to each activity included on poster 40. As further discussed below, the activities are scheduled for different times and/or durations during the accelerated exam preparation program. When each student creates his/her own schedule, various planning techniques can be used so that it can be quickly planned. For example, the student can determine a time period for each day of the program that he/she can completely devote to studying, identify a location that can be used for studying, plan a menu and purchase food so that the diet guidelines are easily followed, etc. The student can schedule the entire twenty-four hour period for each day of the accelerated exam preparation program, including the exam day. As discussed further below, entries on poster 40 may include meal/snack time, exercise time, content study time (mind maps, practice sheets, summary sheet, etc.), relaxation time (breathing, yoga, etc.), and an exam day plan (location, paperwork, breakfast, snacks, etc.).

When the mind is in a state of relaxed concentration (i.e., settled, quiet), its ability to absorb new material is dramatically improved over when the mind is anxious and/or stressed. Returning to FIG. 2, in steps S3 and S6, the student's mind is relaxed using mind relaxation component 16 (FIG. 1). Various techniques can be used to obtain a relaxed state of mind. For example, mind relaxation component 16 can include instructions on how to perform alternative nostril breathing (i.e., Prayana breathing in yoga). To perform alternative nostril breathing, the student holds one nostril closed while deeply inhaling with the other nostril. To exhale, the nostril used to inhale is closed. The process is repeated, alternating nostrils through which the student inhales. Alternative nostril breathing can be done in sets of ten approximately every ninety minutes, before the start of a practice exam, before the actual exam, and/or every hour during the exam. Studying for an extended period of time, the student may remain in a single, sedentary position resulting in headaches, backaches, and/or fatigue. As a result, stretches can also be incorporated to incorporate some movement into the studying routine and help calm the student's mind. For example, every hour or hour and a half during the study period, the student can be instructed to do a series of six yoga stretches known as the sun salutation. To further facilitate learning and memorization, mind relaxation component 16 can further play a musical recording 24 in the sixteen Hertz range in the background, for example, baroque classical music, while the student is presented with the content. Evidence exists that this type of music assists the mind in concentrating and relaxing.

Mind relaxation component 16 can further incorporate one or more psychoacoustic recordings. A psychoacoustic recording is designed to entrain brainwaves so that the student enters a selected state of consciousness. The psychoacoustic recording can be created using a sound machine that provides beats of different frequencies heard in each ear. When heard by the brain, the frequencies cause the brainwaves to enter the selected state of consciousness. In particular, some evidence suggests that two brainwave states accelerate learning and improve retention. First, an alpha accelerator audio recording 26 can be used to place the brain in what is known as the “Alpha State.” In the Alpha State, the student is relaxed and the student's mind is receptive to new ideas and learning. In this state, the student can, for example, repeat a series of affirmations about remaining calm and focused during the exam to assist the student in overcoming negative preconceptions about his/her exam taking ability. Second, a delta accelerator recording 28 can be used to place the brain in what is known as the “Delta State.” The Delta State is obtained during stages of deep, restorative sleep. The delta accelerator recording 28 can further include positive affirmations similar to those included on alpha accelerator recording 26. Mind relaxation component 16 can further include information on other psychoacoustic recordings that can assist the student in obtaining a deep delta state. In one embodiment, alpha accelerator recording 26 and delta accelerator recording 28 comprise tapes having a length of about forty-five minutes, and the student is instructed to listen to each tape each day during the accelerated exam preparation program.

In step S4 of FIG. 2, the content of the exam is presented in a graphical manner to the student using rapid synthesis component 18. Step S4 is shown occurring in parallel with step S3 since, for example, music 24 can be playing while the student is being presented with the content. However, it is understood that some or all of mind relaxation component 16 can be provided before step S4 (i.e., alpha accelerator recording 26), at breaks during step S4 (i.e., yoga breathing and stretching exercises), or after step S4 (i.e., delta accelerator recording 28 in step S6).

Rapid synthesis component 18 includes a mind mapping component 30 that informs the student on how to use a mind mapping technique to quickly assimilate the content on which the exam is based. The mind mapping technique uses various graphical and color recognition strategies to aid the student in quickly recalling content. The mind mapping technique exploits three theories about memory. First, since an individual generally remembers pictures better, the student makes/views an image that includes as many senses as possible. The more multi-sensory the image, the stronger the memory of the image and as a result, its content. Second, since an individual generally remembers locations well, the multi-sensory images are placed in locations to further assist the student in recalling content. Third, since an individual remembers in “chunks” of information (small bits of images that are placed in retrieval locations of the mind), the content is summarized into short segments.

In one embodiment, mind mapping component 30 instructs the student on how to mind map content into short, rapid segments on color coded mind map cards. The student is instructed on how to summarize approximately two to three pages of content on one mind map card (e.g., a three by five index card). Further, the student is instructed on how to create each mind map card in approximately three minutes.

In particular, mind mapping component 30 instructs the student to assign a color to each information area within the content. Preferably, each student should select a color that he/she associates with the information area. For example, a student may select the color green for an information area that deals with money. The student can use the chapters in one or more reference materials to assist the student in determining the various information areas. Once determined, each reference/chapter can be color coded according to the content of the particular reference/chapter so that the student can easily locate the material addressing the information area during a review. Each mind map card summarizing a particular content area is then made using the color selected for the content area.

Mind mapping component 30 then instructs the student to determine an amount of content that will be placed on each mind map card and how much time each will take. In one embodiment, the student is instructed on how to perform an overall review of the layout of the reference(s), decide a logical breakout of the material, and determine how the information will fit on the student's mind map cards. The student can be instructed to use chapter, section, and subsection headings in a reference to organize the mind map cards. For example, if section one of chapter four has four subsections, each of approximately two to three pages in length, the student can be instructed to create four mind map cards, one for each subsection, in the color selected for the content of chapter four.

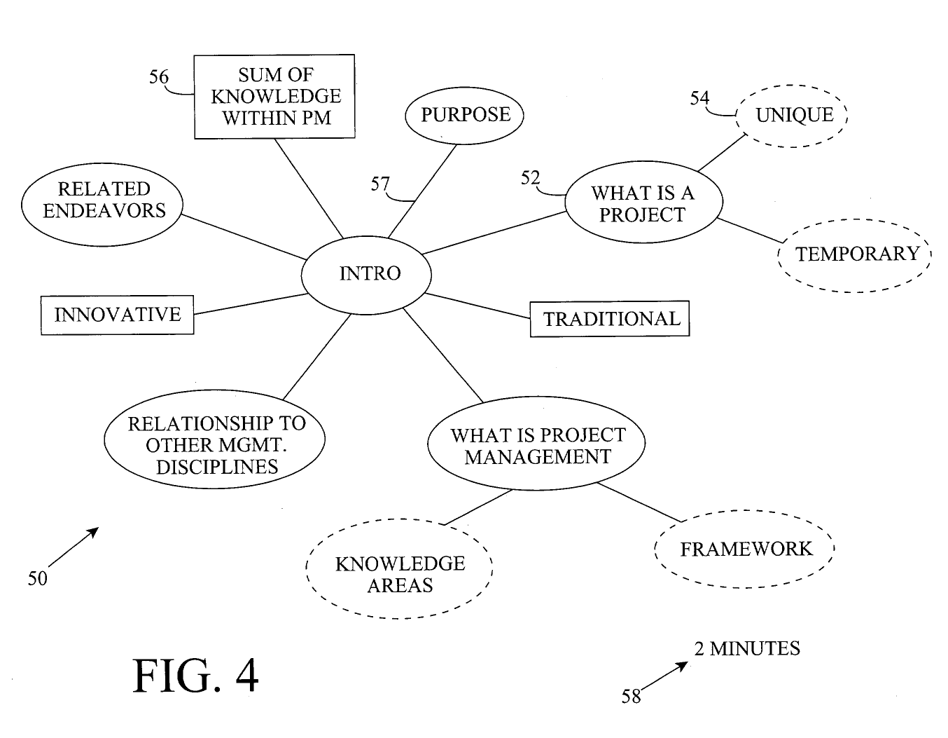

Rapid synthesis component 18 can further instruct a student on creating one or more summary sheets 32. A summary sheet 32 provides a summary of the entire content area and/or each subsection within the content area. In one embodiment, summary sheet 32 comprises a mind map. FIG. 4 depicts an illustrative summary sheet 50 that comprises a mind map of the various subsections within a content area. Summary sheet 50 summarizes one chapter of a reference text on project management. Summary sheet 50 can be color and/or shape coded based on content (e.g., money=green) or by depth (e.g., main point=blue, sub-point=red). Summary sheet 50 uses blue circles 52 for text denoting a main section of the chapter, red circles 54 to denote a subsection of the chapter, and purple squares 56 to denote summaries of the overall content of the chapter. Lines 57 as well as the location of the text are used to provide further indications of the organization and logical structure of the content. By incorporating various visual indications, summary sheet 50 assists the student in reducing the amount of review time typically required, aids in quick recall of the content, and provides a basis for quickly synthesizing the content. Summary sheet 50 also includes an indicator 58 of the amount of time allocated for creating summary sheet 50. Limiting the amount of time that the student can spend in creating the card further assists the student in maintaining focus and concentration. The student can further include a key heading on each summary sheet 50 and/or mind mapping card to facilitate their use as flash cards when the student is reviewing the content for the exam.

Rapid synthesis component 18 can further instruct the student to create a one sheet summary of all the content on which the exam is based. After mapping out the content, the student can identify the key content that is expected to appear on the exam. The student can then create a one sheet summary that includes this information. In final preparation for the exam, the student memorizes the content of the summary sheet. In one embodiment, the student incorporates memory devices such as mnemonics to assist the student in memorizing the content. Humorous mnemonics can be used to help recall of the content and to reduce stress that the student may be experiencing during preparation and during the exam. When the student is allowed to use scratch paper during the exam, the student can learn to quickly reproduce the summary sheet. For example, the student can seek to reproduce the summary sheet in under fifteen minutes so that it can subsequently be used during the exam, and reproducing it does not consume too much of the time allotted for the exam. When a course instructor presents the course, he/she can periodically test the students on their ability to quickly reproduce the summary sheet, and grade the students on their success. The grade can be correlated with the student's performance on practice tests to further motivate and focus each student's attention in remembering the important concepts for the exam.

In step S5 of FIG. 2, one or more additional senses can be incorporated while the student is presented with the content using sensory component 34. For example, the student can eat a breath mint while learning the content. Subsequently, during the exam, the student can eat the same flavored breath mint. When presented with the familiar smell and taste, the student's taste and smell senses further assist in quickly recalling the content.

Some or all of steps S3-S6 can be repeated for each day of an accelerated exam preparation program that lasts more than one day. After the accelerated exam preparation program is complete, the student takes the exam in Step S7. As discussed previously, various techniques incorporated in the accelerated exam preparation are used during the exam. For example, the student may recreate the summary sheet, eat a protein snack, perform one or more exercises, recreate a smell/taste, etc.

It is understood, that while the invention is described as comprising various components and steps for instructing students, the invention can be implemented in numerous embodiments. For example, the invention can comprise a workbook or a kit in which mind map cards, and/or summary sheets have been partially or completely provided to the students. Further, the invention can be provided as part of an instructional course, or as a self-study course. In either case, a system embodying the invention can comprise a computer software program that enables the student to create or provides the student with the various lifestyle information, planning information, mind map cards and/or summary sheets, plays various recordings, and/or generates smells. In this case, the various systems, functions, mechanisms, components, methods, and modules can be implemented using hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. An accelerated exam preparation system, comprising:
a planning component for planning a preparation schedule for a student;
a mind relaxation component for relaxing the mind of the student; and
a rapid synthesis component for presenting content to the student in a graphical manner.

2. The system of claim 1, further comprising a lifestyle management component for advising the student on improving at least one of: a physical state and a mental state.

3. The system of claim 2, wherein the lifestyle management component comprises diet and exercise information.

4. The system of claim 1, wherein the mind relaxation component comprises at least one audio recording.

5. The system of claim 4, wherein the at least one audio recording comprises at least one of an alpha accelerator recording for stimulating an alpha state in the brain of the student, a delta accelerator recording for stimulating a delta state in the brain of the student, and musical recording having a range of about sixteen Hertz.

6. The system of claim 1, wherein the rapid synthesis component comprises a mind mapping component for learning the content.

7. The system of claim 6, wherein the mind mapping component comprises a plurality of color-coded cards for storing information.

8. The system of claim 1, wherein the rapid synthesis component comprises a summary sheet summarizing the content that incorporates at least one of: uniquely identifying content areas and mnemonics.

9. The system of claim 1, wherein the rapid synthesis component comprises a sensory component for incorporating at least one of: taste and smell during learning.

10. The system of claim 1, wherein the planning component comprises a poster.

11. A method for preparing a student for an exam, comprising:
advising the student on improving at least one of: a physical state and a mental state of the student; and
providing a course to the student, the course comprising:
planning a preparation schedule for the student;
relaxing the mind of the student during the course; and
presenting content to the student in a graphical manner.

12. The method of claim 11, wherein the advising step includes at least one of: suggesting an adjustment to the intake of at least one drug by the student, outlining an exercise program for the student, and outlining a dietary program for the student.

13. The method of claim 11, wherein the relaxing step includes playing a musical composition having a range of about sixteen Hertz.

14. The method of claim 11, wherein the graphical manner comprises a plurality of cards, wherein each card includes a mind map for at least some of the content.

15. The method of claim 14, wherein each mind map is color coded based on a topic and wherein each mind map incorporates at least one graphical indicator selected from: a location for information and a shape surrounding information.

16. The method of claim 11, wherein the providing step further includes incorporating at least one of: taste and smell during the course.

17. An accelerated exam preparation system, the system comprising:
a lifestyle management component for advising a student on improving at least one of: a physical state and a mental state;
a planning component for planning a preparation schedule for the student;
a mind relaxation component that includes a musical recording having a range of about sixteen Hertz; and
a rapid synthesis component for presenting content to the student in a graphical manner.

18. The system of claim 17, wherein the lifestyle management component comprises diet and exercise information.

19. The system of claim 17, wherein the mind relaxation component further includes at least one of an alpha accelerator recording for stimulating an alpha state in the brain of the student, and a delta accelerator recording for stimulating a delta state in the brain of the student.

20. The system of claim 17, wherein the rapid synthesis component comprises:
a mind mapping component for learning the content, the mind mapping component including:
a plurality of color-coded cards for presenting information; and
at least one summary card for summarizing the content;
a summary sheet summarizing the content; and
a sensory component for incorporating at least one of: taste and smell during learning.
